(19) United States
(12) Patent Application Publication
(10) Pub. No.: US 2013/0285380 A1
(43) Pub. Date: Oct. 31, 2013

(54) THERMAL STORAGE SYSTEM AND METHODS

(71) Applicant: Leon Afremov, Tel Aviv (IL)

(72) Inventor: Leon Afremov, Tel Aviv (IL)

(73) Assignee: BRIGHTSOURCE INDUSTRIES (ISRAEL) LTD., Jerusalem (IL)

(21) Appl. No.: 13/976,925

(22) PCT Filed: Jan. 3, 2012
(86) PCT No.: PCT/IB12/50026

§ 371 Date: Jun. 27, 2013

Related U.S. Application Data
(60) Provisional application No. 61/429,288, filed on Jan. 3, 2011.

(51) Int. Cl. F03G 6/06; F24J 2/34; F01D 15/10; F24J 2/30

(52) U.S. Cl. CPC F03G 6/065; F24J 2/30; F24J 2/34; F01D 15/10
USPC 290/52; 60/641.8; 126/714; 126/641; 126/645

(57) ABSTRACT

Insolation can be used to heat a solar fluid for use in generating electricity. During periods of relatively higher insolation, excess enthalpy in a superheated solar fluid can be stored in a thermal storage system for subsequent use during periods of relatively lower insolation or at times when supplemental electricity generation is necessary. Enthalpy from superheated solar fluid can be transferred to the thermal storage system so as to heat a storage medium therein, but the enthalpy transfer can be limited such that the superheated solar fluid does not condense or only partially condenses. The remaining enthalpy in the de-superheated solar fluid can be used for other applications, such as, but not limited to, preheating the solar fluid for an evaporating solar receiver, supplementing the input to a superheating solar receiver, industrial applications, resource extraction, and/or fuel production.

### CROSS-REFERENCE TO RELATED APPLICATIONS

The present application claims the benefit of U.S. Provisional Application No. 61/429,288, filed Jan. 3, 2011, which is incorporated by reference herein in its entirety.

### FIELD

The present disclosure relates generally to energy production using solar insolation, and, more particularly, to storage of solar energy using thermal storage reservoirs.

### SUMMARY

Insolation can be used to heat a solar fluid (e.g., water or carbon dioxide) for use in generating electricity (e.g., via a steam turbine). During periods of relatively higher insolation, there can be excess heat energy (i.e., enthalpy) in superheated solar fluid than what is needed for electricity generation. In contrast, during periods of relatively lower insolation (e.g., cloud cover or at night), the enthalpy in the solar fluid can be insufficient to generate electricity. In general, during the periods of relatively higher insolation, the excess enthalpy can be stored in a thermal storage system (i.e., charging the storage system) for subsequent use, for example, during periods of relatively lower insolation or at times when supplemental electricity generation is necessary (e.g., during peak power periods). During charging of the thermal storage system, enthalpy from superheated solar fluid can be transferred to the thermal storage system so as to heat a storage medium therein, but the enthalpy transfer can be limited such that the superheated solar fluid does not condense or only partially condenses. The enthalpy remaining in the resulting de-superheated solar fluid can be used for other applications, such as, but not limited to, preheating the solar fluid for an evaporating solar receiver, supplementing the input to a superheating solar receiver, domestic or industrial applications, resource extraction, and fuel production.

In one or more embodiments, a method of generating electricity using insolation can include, at a first operating period, generating superheated steam at a pressure greater than atmospheric pressure using insolation, and using a first portion of the generated superheated steam to drive a turbine so as to produce electricity. A second portion of the generated superheated steam can be directed to a first flowpath of a first heat exchanger in thermal communication with first and second thermal reservoirs. At a same time as the directing, a storage medium can be flowed from the first reservoir along a second flowpath of the first heat exchanger to the second reservoir such that enthalpy in the second portion of the generated superheated steam in the first flowpath is transferred to the storage medium in the second flowpath so as to heat the storage medium from a first temperature below the boiling point of water at said pressure to a second temperature above the boiling point of water. The fluid exiting from the first flowpath of the first heat exchanger has a temperature at or greater than the boiling point of water at said pressure, and at least some of the fluid exiting the first flowpath of the first heat exchanger remains in the form of steam. The method can further include, at a second operating period, reverse-flowing the storage medium from the second reservoir along the second flowpath of the first heat exchanger to the first reservoir such that enthalpy in the storage medium in the second flowpath is transferred to pressurized water in the first flowpath of the first heat exchanger so as to generate steam. The steam generated by said reverse-flowing can then be used to drive the turbine so as to produce electricity. The storage medium can include at least one of a molten salt and a molten metal. An insolation level during the first operating period can be greater than that during the second operating period.

In one or more embodiments, a system for generating electricity from insolation can include a solar collection system, a thermal storage system, an electricity generating system, a first heat exchanger, and a control system. The solar collection system can be constructed to generate steam from insolation. The thermal storage system can include first and second thermal storage reservoirs. The electricity generating system can include a turbine that uses steam to generate electricity and can be coupled to the solar collection system so as to receive generated steam therefrom. The first heat exchanger can thermally couple the solar collection system and the thermal storage system to each other such that enthalpy in one of the solar collection and thermal storage systems can be transferred to the other of the solar collection and thermal storage systems. The control system can be configured to control the thermal storage system such that, during a first operating period, storage medium flows from the first reservoir through the first heat exchanger to the second reservoir so as to transfer enthalpy in steam from the solar collection system to the storage medium by way of the first heat exchanger. The control system can be also configured to control the thermal storage system such that, during a second operating period, storage medium flows from the second reservoir through the first heat exchanger to the first reservoir so as to transfer enthalpy from the storage medium to water by way of the first heat exchanger. The control system can also control the thermal storage system such that the temperatures of the steam and the storage medium exiting the first heat exchanger during the first operating period are at or above the boiling point of water.

In one or more embodiments, a method of thermal storage of solar energy can include, during a first time, transferring enthalpy to a thermal storage medium from a first portion of a vapor-phase solar fluid at a first pressure so as to increase a temperature of the thermal storage medium. The transfer can be such that a temperature of said first portion of the solar fluid after the enthalpy transfer remains greater than or equal to a boiling point temperature of said solar fluid at the first pressure. The vapor-phase solar fluid can be generated using solar insolation.

In one or more embodiments, a method of charging a thermal storage system can include effecting a first heat transfer process whereby enthalpy is transferred from superheated pressurized steam at a first pressure to a thermal storage medium so as to substantially cool the superheated steam to its boiling point temperature, T_{BP}, at the first pressure without completely condensing the steam and while heating the thermal storage medium from an initial temperature, T_{S2}, to a destination temperature, T_{S1}. An initial temperature, T₃, of the superheated steam can exceed the boiling point temperature T_{BP} by ΔT₃. The thermal storage medium destination temperature T_{S1} can exceed the boiling point temperature T_{BP} by ΔT₁. The thermal storage medium initial temperature T_{S2} can be less than the boiling point temperature T_{BP} by ΔT₂. The steam can be cooled to a temperature, T₄, at the boiling point temperature T_{BP} or above the boiling point temperature T_{BP} by ΔT₄. A ratio of ΔT₁ to ΔT₃ can be at least 0.5.

In one or more embodiments, a solar energy system can include first and second solar receivers, a steam separation vessel, a thermal energy storage system, a first heat exchanger assembly, and a conduit assembly. The first solar receiver can be configured to evaporate pressurized feedwater using insolation. The second solar receiver can be configured to superheat pressurized steam using insolation. The steam separation vessel can be in fluid communication with each of the first and second receivers. The thermal energy storage system can include first and second reservoirs for a thermal storage medium. The thermal storage medium can be selected from molten salt and molten metal. The first heat exchanger assembly can include one or more exchangers. The first heat exchanger assembly can be configured to enable a heat transfer process between superheated steam and the thermal storage medium during charging of the thermal energy storage system, and between the thermal storage medium and pressurized water and/or steam during discharging. The conduit assembly can include one or more conduits. The conduit assembly can be configured to deliver de-superheated and at most partially condensed steam from the first heat exchanger assembly to one of the steam separation vessel, a feedwater loop, and a second heat exchanger assembly in thermal communication with the pressurized feedwater.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some features have not been illustrated to assist in the illustration and description of underlying features. Throughout the figures, like reference numerals denote like elements.

FIG. 1 shows a solar power tower system, according to one or more embodiments of the disclosed subject matter.

FIG. 2 shows a solar power tower system with secondary reflector, according to one or more embodiments of the disclosed subject matter.

FIG. 3 shows a solar power tower system including multiple towers, according to one or more embodiments of the disclosed subject matter.

FIG. 4 shows a solar power tower system including multiple receivers in a single tower, according to one or more embodiments of the disclosed subject matter.

FIG. 5 is a schematic diagram of a heliostat control system, according to one or more embodiments of the disclosed subject matter.

FIG. 6A is a simplified diagram showing a first arrangement for and connections between the storage reservoirs of a thermal storage system, according to one or more embodiments of the disclosed subject matter.

FIG. 6B is a simplified diagram showing alternative connections between the storage reservoirs of a thermal storage system, according to one or more embodiments of the disclosed subject matter.

FIG. 7 is a flow diagram illustrating an exemplary method of charging and discharging a thermal storage system, according to one or more embodiments of the disclosed subject matter.

FIG. 8 is a simplified diagram showing the interaction between a solar collection system, a thermal storage system, and an electricity generation system during a charging mode, according to one or more embodiments of the disclosed subject matter.

FIG. 9 is a simplified diagram showing the interaction between a solar collection system, a thermal storage system, and an electricity generation system during a discharging mode, according to one or more embodiments of the disclosed subject matter.

FIG. 10A shows a first configuration for various components of a solar collection system, a thermal storage system, and an electricity generation system, according to one or more embodiments of the disclosed subject matter.

FIG. 10B shows a second configuration for various components of a solar collection system, a thermal storage system, and an electricity generation system, according to one or more embodiments of the disclosed subject matter.

FIG. 10C shows a third configuration for various components of a solar collection system, a thermal storage system, and an electricity generation system, according to one or more embodiments of the disclosed subject matter.

FIG. 11 shows isobaric temperature-heat flow curves for a solar fluid, according to one or more embodiments of the disclosed subject matter.

FIG. 12 shows temperature-heat flow curves for a solar fluid and a thermal storage medium and various temperature relationships, according to one or more embodiments of the disclosed subject matter.

### DETAILED DESCRIPTION

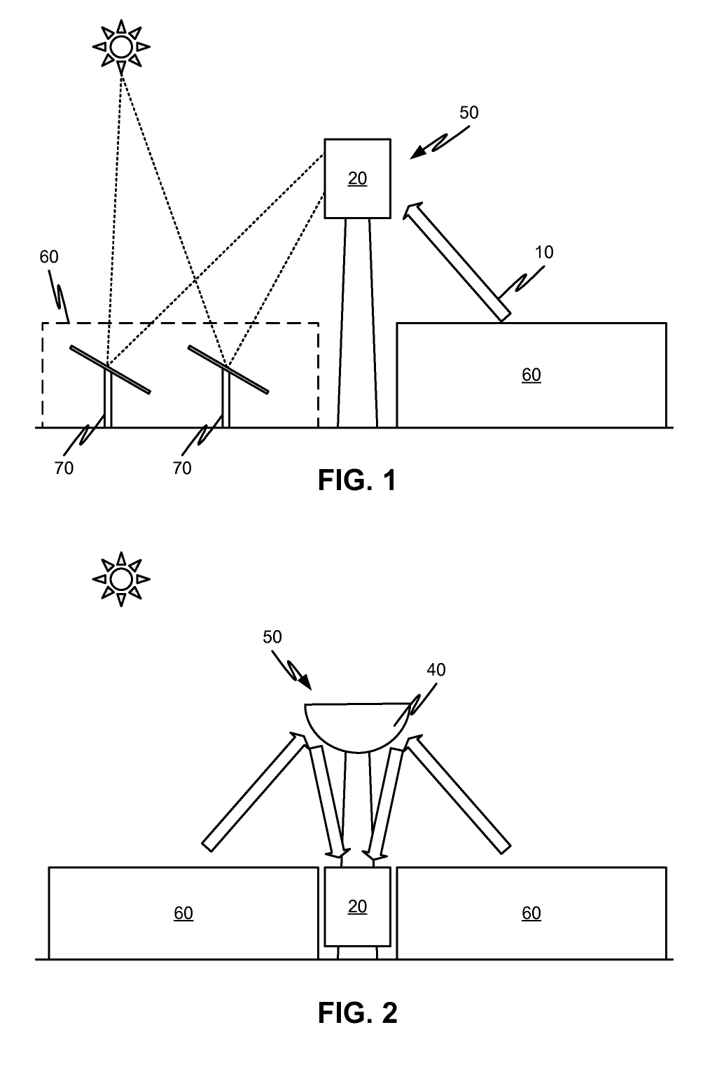

Insolation can be used by a solar tower system to generate solar steam and/or for heating molten salt. In FIG. 1, a solar tower system can include a solar tower 50 that receives reflected focused sunlight 10 from a solar field 60 of heliostats (individual heliostats 70 are illustrated in the left-hand portion of FIG. 1 only). For example, the solar tower 50 can have a height of at least 25 meters, 50 meters, 75 meters, or higher. The heliostats 70 can be aimed at solar energy receiver system 20, for example, a solar energy receiving surface of one or more receivers of system 20. Heliostats 70 can adjust their orientation to track the sun as it moves across the sky, thereby continuing to reflect sunlight onto one or more aiming points associated with the receiver system 20. A solar energy receiver system 20, which can include one or more individual receivers, can be mounted in or on solar tower 50. The solar receivers can be constructed to heat water and/or steam and/or supercritical steam and/or any other type of solar fluid using insolation received from the heliostats. Alternatively or additionally, the target or receiver 20 can include, but is not limited to, a photovoltaic assembly, a steam-generating assembly (or another assembly for heating a solid or fluid), a biological growth assembly for growing biological matter (e.g., for producing a biofuel), or any other target configured to convert focused insolation into useful energy and/or work.

The solar energy receiver system 20 can be arranged at or near the top of tower 50, as shown in FIG. 1. In another embodiment, a secondary reflector 40 can be arranged at or near the top of a tower 50, as shown in FIG. 2. The secondary reflector 40 can thus receive the insolation from the field of heliostats 60 and redirect the insolation (e.g., through reflection) toward a solar energy receiver system 20. The solar energy receiver system 20 can be arranged within the field of heliostats 60, outside of the field of heliostats 60, at or near ground level, at or near the top of another tower 50, above or below reflector 40, or elsewhere.

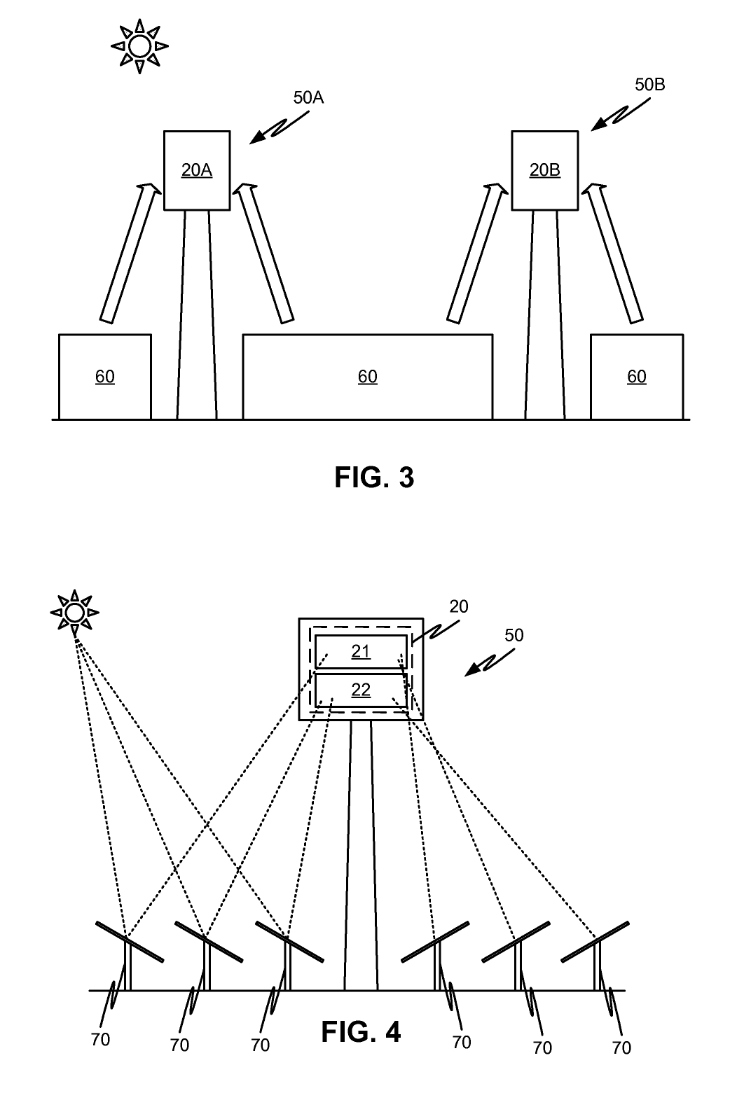

More than one solar tower 50 can be provided, each with a respective solar energy receiving system thereon, for example, a solar power steam system. The different solar energy receiving systems can have different functionalities. For example, one of the solar energy receiving systems can heat water using the reflected solar radiation to generate steam while another of the solar energy receiving systems can serve to superheat steam using the reflected solar radiation. The multiple solar towers 50 can share a common heliostat field 60 or have respective separate heliostat fields. Some of the heliostats can be constructed and arranged so as to alternatively direct insolation at solar energy receiving systems in different towers. In addition, the heliostats can be configured to direct insolation away from any of the towers, for example, during a dumping condition. As shown in FIG. 3, two solar towers can be provided, each with a respective solar energy receiving system. A first tower 50A has a first solar energy receiving system 20A while a second tower 50B has a second solar energy receiving system 20B. The solar towers 50A, 50B are arranged so as to receive reflected solar radiation from a common field of heliostats 60. At any given time, a heliostat within the field of heliostats 60 can be directed to a solar receiver of any one of the solar towers 50A, 50B. Although only two solar towers with respective solar energy receiving systems are shown in FIG. 3, any number of solar towers and solar energy receiving systems can be employed.

More than one solar receiver can be provided on a solar tower. The multiple solar receivers in combination can form a part of the solar energy receiving system 20. The different solar receivers can have different functionalities. For example, one of the solar receivers can heat water using the reflected solar radiation to generate steam while another of the solar receivers can serve to superheat steam using the reflected solar radiation. The multiple solar receivers can be arranged at different heights on the same tower or at different locations (e.g., different faces, such as a north face, a west face, etc.) on the same tower. Some of the heliostats in field 60 can be constructed and arranged so as to alternatively direct insolation at the different solar receivers. As shown in FIG. 4, two solar receivers can be provided on a single tower 50. The solar energy receiving system 20 thus includes a first solar receiver 21 and a second solar receiver 22. At any given time, a heliostat 70 can be aimed at one or both of the solar receivers, or at none of the receivers. In some use scenarios, the aim of a heliostat 70 can be adjusted so as to move a centroid of the reflected beam projected at the tower 50 from one of the solar receivers (e.g., 21) to the other of the solar receivers (e.g., 22). Although only two solar receivers and a single tower are shown in FIG. 4, any number of solar towers and solar receivers can be employed.

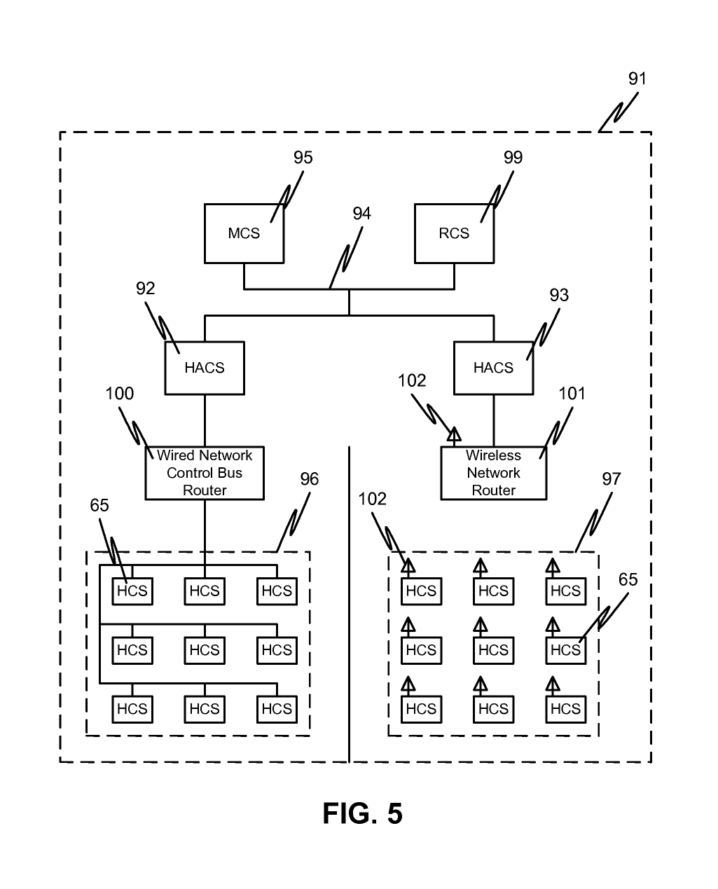

Heliostats 70 in a field 60 can be controlled through a central heliostat field control system 91, for example, as shown in FIG. 5. For example, a central heliostat field control system 91 can communicate hierarchically through a data communications network with controllers of individual heliostats. FIG. 5 illustrates a hierarchical control system 91 that includes three levels of control hierarchy, although in other implementations there can be more or fewer levels of hierarchy, and in still other implementations the entire data communications network can be without hierarchy, for example, in a distributed processing arrangement using a peer-to-peer communications protocol.

At a lowest level of control hierarchy (i.e., the level provided by heliostat controller) in the illustration there are provided programmable heliostat control systems (HCS) 65, which control the two-axis (azimuth and elevation) movements of heliostats (not shown), for example, as they track the movement of the sun. At a higher level of control hierarchy, heliostat array control systems (HACS) 92, 93 are provided, each of which controls the operation of heliostats 70 (not shown) in heliostat fields 96, 97, by communicating with programmable heliostat control systems 65 associated with those heliostats 70 through a multipoint data network 94 employing a network operating system such as CAN, Devicenet, Ethernet, or the like. At a still higher level of control hierarchy a master control system (MCS) 95 is provided which indirectly controls the operation of heliostats in heliostat fields 96, 97 by communicating with heliostat array control systems 92, 93 through network 94. Master control system 95 further controls the operation of a solar receiver (not shown) by communication through network 94 to a receiver control system (RCS) 99.

In FIG. 5, the portion of network 94 provided in heliostat field 96 can be based on copper wire or fiber optic connections, and each of the programmable heliostat control systems 65 provided in heliostat field 96 can be equipped with a wired communications adapter, as are master control system 95, heliostat array control system 92 and wired network control bus router 100, which is optionally deployed in network 94 to handle communications traffic to and among the programmable heliostat control systems 65 in heliostat field 96 more efficiently. In addition, the programmable heliostat control systems 65 provided in heliostat field 97 communicate with heliostat array control system 93 through network 94 by means of wireless communications. To this end, each of the programmable heliostat control systems 65 in heliostat field 97 is equipped with a wireless communications adapter 102, as is wireless network router 101, which is optionally deployed in network 94 to handle network traffic to and among the programmable heliostat control systems 65 in heliostat field 97 more efficiently. In addition, master control system 95 is optionally equipped with a wireless communications adapter (not shown).

Insolation can vary both predictably (e.g., diurnal variation) and unpredictably (e.g., due to cloud cover, dust, solar eclipses, or other reasons). During these variations, insolation can be reduced to a level insufficient for heating a solar fluid, for example, producing steam for use in generating electricity. To compensate for these periods of reduced insolation, or for any other reason, thermal energy produced by the insolation can be stored in a fluid-based thermal storage system for use later when needed. The thermal storage system can store energy when insolation is generally available (i.e., charging the thermal storage system) and later release the energy to heat a solar fluid (e.g., water or carbon dioxide) in addition to or in place of insolation. For example, it can be possible at night to replace the radiative heating by insolation of the solar fluid in the solar collection system with conductive and/or convective heat transfer of thermal energy (i.e., enthalpy) from a thermal storage system to the solar fluid. Although the term solar fluid is used herein to refer to the fluid heated in the solar collection system, it is not meant to require that the solar fluid actually be used to produce work (e.g., by driving a turbine). For example, the solar fluid as used herein can release heat energy stored therein to another fluid which can in turn be used to produce useful work or energy. The solar fluid can thus act as a heat transfer fluid or a working fluid.

In one or more embodiments, the thermal storage system includes at least two separate thermal storage reservoirs, which can be substantially insulated to minimize heat loss therefrom. A thermal storage medium can be distributed among or in one of the two storage reservoirs. For example, the thermal storage medium can be a molten salt and/or molten metal and/or other high temperature (i.e., >250° C.) substantially liquid medium. The thermal storage medium can be heated by convective or conductive heat transfer from the solar fluid in a heat exchanger. This net transfer of enthalpy to the thermal storage medium in the thermal storage system is referred to herein as charging the thermal storage system. At a later time when insolation decreases, the direction of heat exchange can be reversed to transfer enthalpy from the thermal storage medium to the solar fluid via the same or a different heat exchanger. This net transfer of enthalpy from the thermal storage medium of the thermal storage system is referred to herein as discharging the thermal storage system.

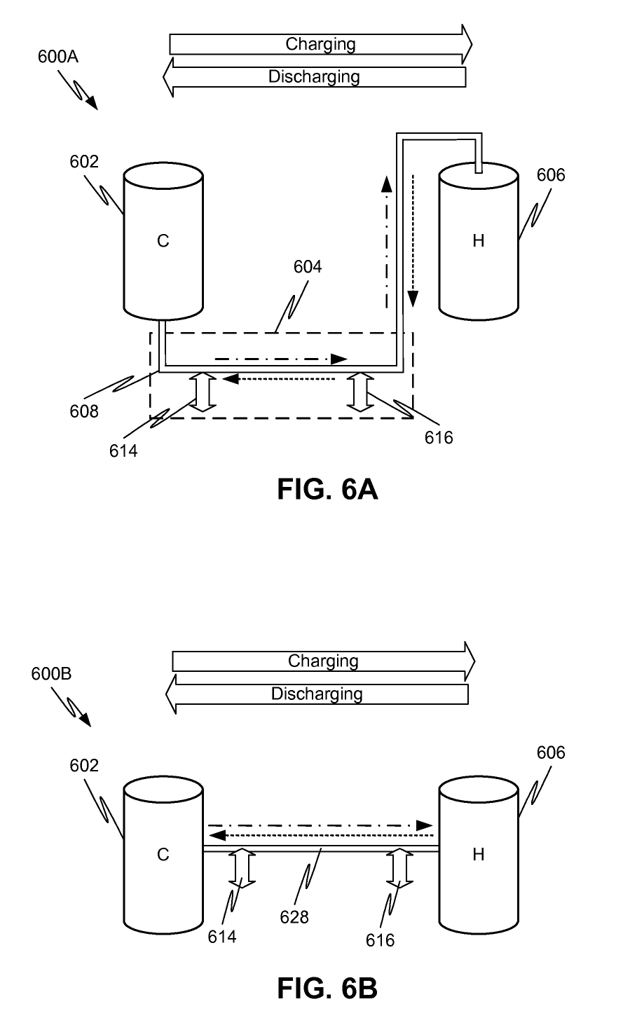

Each thermal storage reservoir can be, for example, a fluid tank or a below-grade pool. Referring to FIG. 6A, a thermal storage system 600A with fluid tanks as the thermal storage reservoir is shown. A first fluid tank 602 can be considered a relatively cold reservoir, in that the temperature during the charging and/or discharging modes is maintained at substantially a temperature of T_{C}, which is the lowest temperature in the thermal storage system. A second fluid tank 606 can be considered a relatively hot reservoir, in that the temperature during the charging and/or discharging modes is maintained at substantially a temperature of T_{H}, which is the highest temperature in the thermal storage system.

During the charging phase (flow directions illustrated by dash-dot lines in the figure), thermal storage medium can be transferred from the colder reservoirs of the thermal storage system to the hotter reservoirs of the thermal storage system, as designated by the block arrow in FIG. 6A. During the discharging phase (flow directions illustrated by dotted lines in the figure), the flow of thermal storage medium can be reversed so as to flow from the hotter reservoirs to the colder reservoirs of the thermal storage system, as designated by the block arrow in FIG. 6A. Thus, storage medium in the first reservoir 602 can be transferred via fluid conduit or pipe 608 to the second reservoir 606 in the charging phase and reversed in the discharging phase.

During the charging or discharging modes, enthalpy can be exchanged between the solar fluid and the thermal storage medium as the thermal storage medium passes between the reservoirs. The fluid conduits or pipes can be in thermal communication with the solar fluid by way of a heat exchanger to allow the transfer of enthalpy as the thermal storage fluid flows between reservoirs (i.e., while the thermal storage medium is en route to a destination reservoir). For example, conduit 608 connecting the first reservoir 602 to the second reservoir 606 can pass through a heat exchanger 604 such that the thermal storage medium can exchange enthalpy 614 and 616 with the solar fluid. The direction of enthalpy flow depends on the mode of operation, with enthalpy flowing from the solar fluid to the thermal storage medium during the charging phase and from the thermal storage medium to the solar fluid during the discharging phase. Portions of the fluid conduit 608 can be insulated to minimize or at least reduce heat loss therefrom.

Enthalpy 614 can correspond to the decrease in temperature of the solar fluid from an initial superheated temperature to its boiling point temperature while enthalpy 616 can correspond to the release of latent heat as the solar fluid changes phase at the boiling point temperature. As discussed below, the enthalpy exchange can be controlled such that the superheated solar fluid does not fully condense so that it can be used in other applications after charging the thermal storage system. In some embodiments, the solar fluid can be maintained at a temperature above the boiling point (i.e., no condensation at all) after charging of the thermal storage system. In other embodiments, a fraction of the solar fluid can be condensed into the liquid phase while the remainder is in the vapor phase at or above the boiling point. The enthalpy remaining in the solar fluid after charging the thermal storage system can be applied to other uses within the system, such as, but not limited to, preheating solar fluid, supplementing solar receiver inputs, domestic or industrial applications, and fuel production or extraction.

The particular arrangement and configuration of fluid conduit 608 in FIG. 6A is for illustration purposes only. Variations of the arrangement, number, and configuration of the fluid conduit are also possible according to one or more contemplated embodiments. Such a variation is shown in FIG. 6B, where fluid conduit 628 is provided between the different reservoirs of the thermal storage system 600B. As with the configuration of FIG. 6A, one or more heat exchangers can be placed in thermal communication with the fluid conduit to enable transfer of enthalpy 614, 616. In addition, multiple fluid conduits can be provided in parallel, such that fluid flowing between the reservoirs can be distributed across the multiple conduits. Alternatively or additionally, multiple fluid conduits can be provided in parallel, but with fluid flow in one conduit being opposite to that in the other conduit. For example, a return conduit can be provided between the first reservoir and the second reservoir in addition to a forward conduit such that at least some fluid can be returned to the first reservoir. The direction of the net flow between the reservoirs (i.e., the flow in the forward conduit(s) minus the flow in the reverse conduit(s)) can depend on the particular mode of operation. For example, the net flow in the charging phase can be from the colder reservoir to the hotter reservoir and reversed in the discharging phase.

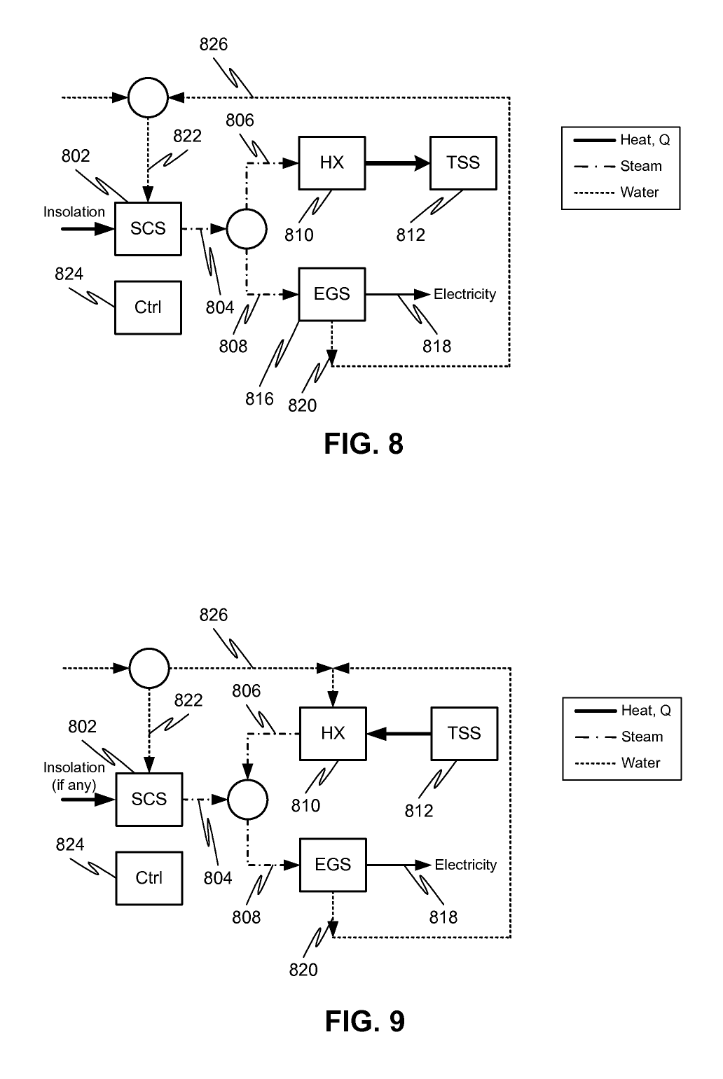

One or more pumps (not shown) can be included for moving the thermal storage medium between reservoirs. Additional flow control components can also be provided, including, but not limited to, valves, switches, and flow rate sensors. Moreover, a controller (for example, see FIG. 8) can be provided. The controller can control the thermal storage fluid medium within the thermal storage system. The controller can include any combination of mechanical or electrical components, including analog and/or digital components and/or computer software. In particular, the controller can control the storage medium flow in tandem with the solar fluid to maintain a desired temperature profile within the thermal storage system for optimal (or at least improved) heat transfer efficiency. For example, during the charging and/or discharging phases, the second reservoir can be maintained at a temperature, T_{H}, above the phase change temperature of the solar fluid (i.e., the boiling point temperature of the solar fluid at the particular pressure). The first reservoir can be maintained at a temperature, T_{C}, above the melting point of the thermal storage medium such that the thermal storage medium remains in a substantially fluid phase so as to allow pumping of the thermal storage fluid from the first reservoir. In addition, the temperature, T_{C}, of the first reservoir can be below the phase change temperature of the solar fluid. The difference between T_{H} and T_{C} can be at least 50° C., 100° C., 150° C., 200° C., or more.

The thermal storage system can include a total quantity, Xₜₒₜ, of thermal storage medium distributed between the different thermal storage reservoirs depending on the particular mode of operation and time within the mode. For example, the thermal storage system can be constructed to accommodate a total quantity of fluid of at least 100 tons, 500 tons, 1000 tons, 2500 tons, 5000 tons, 10000 tons, 50000 tons, or more. In the fully discharged state (which can be at the beginning of a charge phase), the distribution of thermal storage medium in the thermal storage system can be such that substantially all of the storage fluid is in the cold reservoir. In the fully charged state (which can be at the beginning of a discharge phase), the distribution of the thermal storage medium in the thermal storage system can be such that substantially all of the storage fluid is in hot reservoir.

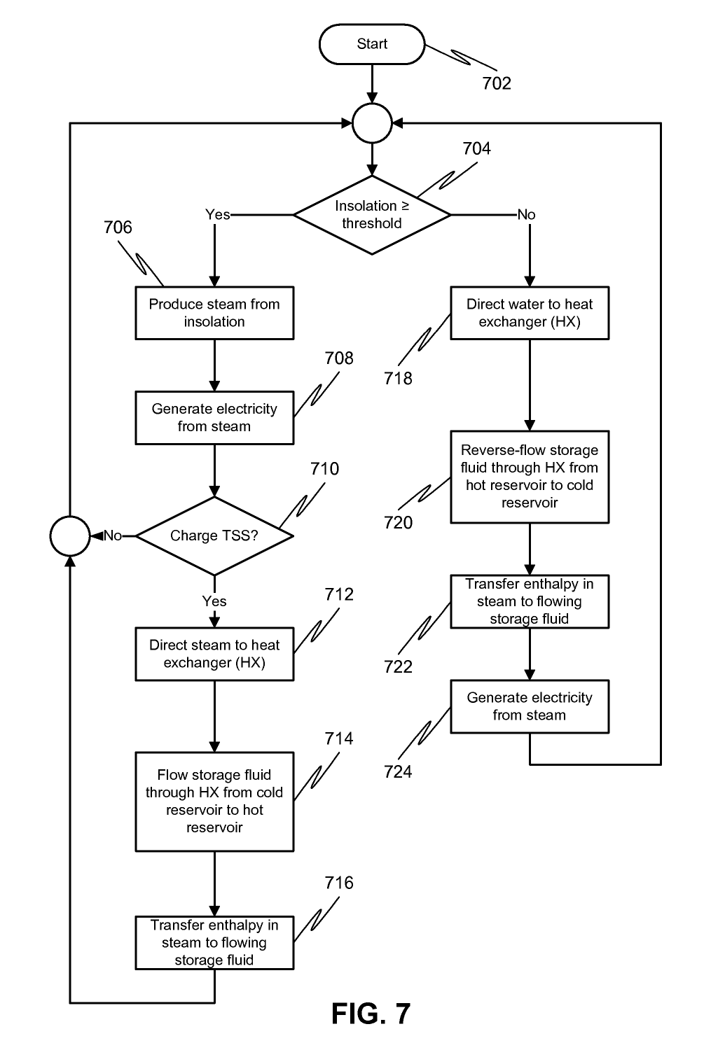

A method for operating the thermal storage system in combination with a solar collector system and an electricity generation system is shown in FIG. 7. The process starts at 702 and proceeds to 704. At 704, it is determined if the insolation is greater than a predetermined level. For example, the predetermined level can be a minimum level for the solar collector system to produce superheated steam for use by an electricity generation system. In addition, 704 can involve prediction based on real-time or simulated data. For example, the determination at 704 can take into account upcoming conditions (e.g., impending cloud cover or dusk) that would result in reduced insolation, thereby allowing the systems to adjust in time to compensate for the reduced insolation levels with minimal (or at least reduced) effect on electricity production. If sufficient insolation is present, the process can proceed to 706.

At 706, the insolation is used to heat a solar fluid to induce a phase change therein, e.g., by evaporating a liquid phase solar fluid to produce a vapor phase solar fluid. For example, when the solar fluid is water, the insolation can be used to produce steam from pressurized water. Such steam production can be done in a two-stage process, with a first stage of insolation serving to evaporate the pressurized (e.g., at a pressure above atmospheric pressure) water into pressurized steam and a second stage of insolation serving to superheat the pressurized steam.

To produce the steam from insolation, a concentrating solar tower system as described above with regard to FIGS. 1-5 can be used. Feedwater can be provided to an evaporating solar receiver at a pressure of at least 25 bars, 50 bars, 75 bars, 100 bars, 125 bars, 150 bars, or greater. A majority of the insolation provided to the evaporating receiver can be used to effect a phase change of the solar fluid (corresponding to latent heat of phase change) as opposed to elevating the temperature of the solar fluid (corresponding to sensible heat). Thus, although the temperature of the solar fluid can increase during the first stage (e.g., in the evaporating solar receiver), an increase in temperature during the first stage is not required. The second stage (e.g., in a superheating solar receiver) further increases the temperature of the vapor-phase solar fluid, for example, by at least 25° C., 50° C., 75° C., 150° C., 200° C., or more. After the steam production via insolation, the process can proceed to 708.

At 708, at least a first portion of the superheated vapor-phase solar fluid can be used to produce useful work, for example, the production of electricity. When the solar fluid is water, the produced steam can be used to drive a turbine to obtain useful work, for example, to drive an electricity generator. Alternatively or additionally, the produced steam can be used for another useful purpose, such as, but not limited to, fossil fuel or biofuel production, fossil fuel extraction, or any other purpose. In addition, as described above, the solar fluid can transfer heat energy therein to another fluid for producing useful work or energy therefrom. For example, the superheated solar fluid can heat water via a heat exchanger to produce steam that is then used to generate useful work, such as by driving a steam turbine. Simultaneously or subsequently, the process can proceed to 710.

At 710, it is determined if the thermal storage system should be charged. The determination can take into account the amount of excess heat energy available and/or the current state of the thermal storage system. For example, during solar collection system startup (e.g., during the early morning hours), there can be insufficient insolation to support both electricity generation and charging of the thermal storage system. The charging can thus be delayed until sufficient insolation levels are present. In another example, charging can be unnecessary if the thermal storage system is considered fully or adequately charged. If charging of the thermal storage system is desired, the process can proceed to 712. Otherwise the process returns to 704 to repeat.

At 712, at least a second portion of the pressurized heated solar fluid (i.e., a different portion from the first portion) can be directed to one or more heat exchangers that are in thermal communication with the thermal storage system. Simultaneously or subsequently, the process can proceed to 714, where thermal storage medium is caused to flow in the thermal storage system. In particular, the thermal storage medium can be flowed from the first reservoir (i.e., the cold reservoir) through the heat exchanger to the second reservoir (i.e., the hot reservoir). Simultaneously or subsequently, the process can proceed to 716, where the enthalpy in the solar fluid is transferred to the flowing thermal storage medium by way of the heat exchanger.

When the solar fluid is water, superheated pressurized steam can enter the heat exchanger at one end. The steam can be superheated by at least 50° C., 75° C., 100° C., 125° C., 150° C., 200° C., or greater. As the solar fluid exchanges enthalpy with the thermal storage medium, the temperature of the superheated solar fluid can drop. However, the enthalpy exchange is regulated such that the solar fluid does not condense or does not drop below the boiling point temperature of the solar fluid. Thus, the enthalpy exchange does not involve any sensible heat of the liquid phase of the solar fluid. Rather, the enthalpy exchange is due to the sensible heat of the vapor phase of the solar fluid and/or the latent heat of phase change of the solar fluid. In some embodiments, a partial harvest of the latent heat of the phase change of the solar fluid can be used to charge the thermal storage medium. For example, at most 80%, 70%, 60%, 50%, 40%, 30%, 20%, or less of the latent heat of phase change of the solar fluid is used to raise the temperature of the thermal storage medium. In other embodiments, all of the enthalpy exchange is due to the sensible heat of the vapor phase of the solar fluid.

Exiting the heat exchanger can be a mixture of pressurized liquid-phase and vapor-phase solar fluid or just de-superheated, pressurized vapor-phase solar fluid. The exiting solar fluid remains mostly pressurized and enthalpy remaining in the solar fluid can thus be used for additional purposes. For example, de-superheated steam can be directed to another heat exchanger for heating pressurized feedwater for supply to an evaporating solar receiver. In another example, the mixture of pressurized water and steam can be directed to a steam separation drum to separate the steam from the water. The separated steam can then be directed to a superheating solar receiver for further heating while the pressurized water can be directed to the evaporating solar receiver for conversion to steam. Directing the de-superheated steam to the steam separation drum can also serve as a way to preheat the feedwater, i.e., by increasing the temperature of the water leaving the drum. In yet another example, the mixture of pressurized water and steam can be directed to a recirculation loop of the evaporating solar receiver. In still another example, the de-superheated steam can be used in one or more industrial purposes, such as fossil fuel production or fossil fuel extraction.

If at 704 it is determined that there is insufficient insolation, the process proceeds to 718. At 718, solar fluid from a solar fluid source can be directed to the heat exchanger. For example, when the solar fluid is water, a pump can pressurize water from a feedwater source to the heat exchanger. Additionally or alternatively, water output from the turbine can be directed to the heat exchanger. Simultaneously or subsequently, the process can proceed to 720, where thermal storage medium is reverse-flowed in the thermal storage system. In particular, the thermal storage medium can be flowed from the second reservoir (i.e., the hot reservoir) through the heat exchanger to the first reservoir (i.e., the cold reservoir). Simultaneously or subsequently, the process can proceed to 722, where the enthalpy in the flowing thermal storage medium is transferred to the solar fluid by way of the heat exchanger. When the solar fluid is water, pressurized water can enter the heat exchanger at one end and leave the heat exchanger at the other end as superheated steam. Enthalpy lost by the flowing thermal storage medium in progressing from the second reservoir to the first reservoir is transferred to the pressurized water to effect a phase change and superheating thereof. The process can then proceed to 724, where the heated solar fluid from the heat exchanger can be used to produce useful work, for example, the production of electricity. When the solar fluid is water, the steam from the heat exchanger can be used to drive a turbine to obtain useful work, for example, to drive an electricity generator. Such electricity production can continue until the thermal storage system is fully discharged, i.e., when a substantial majority of the thermal storage medium is located in the first reservoir. The process can return to 704 to repeat.

Referring to FIGS. 8-9, a simplified diagram of the interaction of a solar collection system, a thermal storage system, and an electricity generation system during the charging and discharging phases is shown. In particular, FIG. 8 shows the system setup and the general flow of heat and fluids during a charging phase while FIG. 9 shows the system setup and the general flow of heat and fluids during a discharging phase. In FIGS. 8-9, a thick arrow represents energy transfer, either in the form of insolation or enthalpy; a dotted arrow represents the flow of solar fluid in the lower enthalpy phase, e.g., water; and a dash-dot arrow represents the flow of solar fluid in the higher enthalpy phase, e.g., steam. Although FIGS. 8-9 will be discussed with respect to water as the solar fluid, it should be understood that other solar fluids can also be used according to one or more contemplated embodiments.

A solar collection system 802 can receive insolation and use the insolation to evaporate pressurized water received via input line 822. The resulting steam (which can be further superheated in solar collection system 802 using the insolation) can be output from the solar collection system 802 via output line 804. The steam can be split into at least two portions: a first portion designated for thermal storage and a second portion designated for electricity generation. The relative proportions of the first and second portions can be based on a variety of factors, including, but not limited to, the amount of enthalpy in the generated steam, current electricity demand, current electricity pricing, and predicted insolation conditions. A control system 824 can be provided for regulating the operation of the solar collection system 802, the thermal storage system 812, the electricity generation system 816, the one or more heat exchangers 810, and/or other system or flow control components (not shown). For example, the control system can be configured to execute the method shown in FIG. 7 or other methods disclosed herein.

The first portion of the steam can be directed via line 808 to an electricity generation system 816. The electricity generation system 816 can use the first portion of the steam to produce electricity and/or other useful work at 818. The steam can be condensed in the electricity generation process to produce water, which can be directed via line 820 back to the inlet line 822 of the solar collection system 802 for subsequent use in producing steam. Meanwhile, the second portion of the steam can be directed via input line 806 to heat exchanger 810. The heat exchanger 810 is in thermal communication with a thermal storage system 812. Steam entering the heat exchanger 810 via input line 806 releases enthalpy (via conduction and/or convection) to the thermal storage system 812. However, the enthalpy transfer is regulated such that the amount of enthalpy released by the steam is insufficient to fully condense the steam. The temperature of the steam can thus be lowered in the heat exchanger 810 to a temperature at or above the boiling point temperature of the steam at the given pressure of the steam within the heat exchanger 810. The solar fluid thus exits the heat exchanger 810 as de-superheated steam and/or a mixture of steam and water. The de-superheated steam and/or water can be used for subsequent processes, such as preheating of water for an evaporating solar receiver of the solar collection system 802, supplementing the steam input for a superheating solar receiver of the solar collection system 802, fossil fuel or biofuel production, fossil fuel extraction, domestic or industrial heating, and/or any other contemplated process.

When insolation is insufficient or non-existent, the setup of FIG. 8 for charging the thermal storage system 812 can transition to the setup of FIG. 9 for discharging the thermal storage system 812. In contrast to FIG. 8, the direction of feedwater in FIG. 9 is reversed such that water is input to the one or more heat exchangers 810 via line 826. The direction of enthalpy flow in FIG. 9 is also reversed, such that heat is transferred (via conduction and/or convection) from the thermal storage system 812 to the heat exchanger 810 to heat the pressurized water flowing therethrough. The water in the heat exchanger thus undergoes a phase change and emerges from the heat exchanger 810 as steam (e.g., superheated steam) at line 806. The steam can be provided to the electricity generation system 816 via line 808 for use generating electricity at 818. During the discharging, the solar collection system 802 can continue to produce steam (via line 804) as insolation conditions allow, thereby supplementing the steam production from the heat exchanger 810.

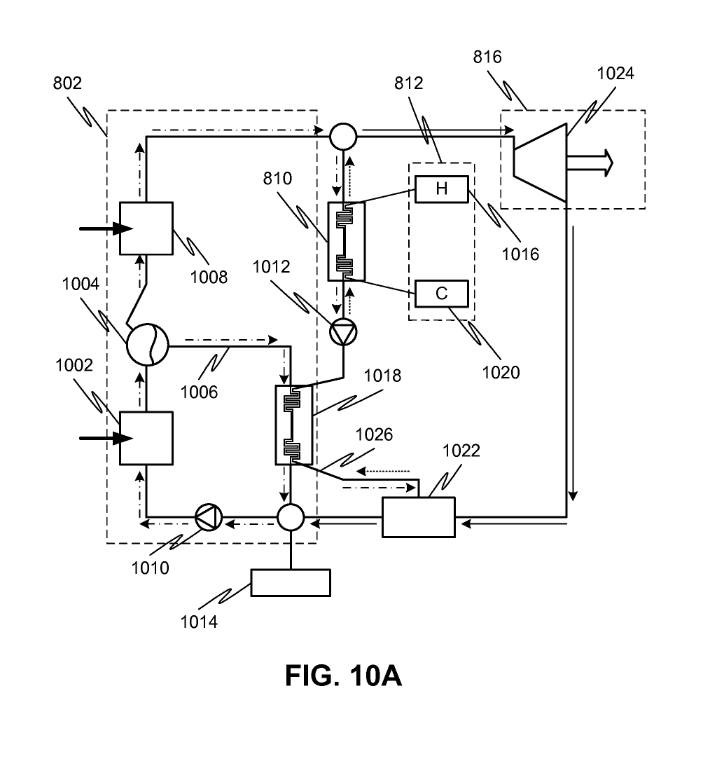

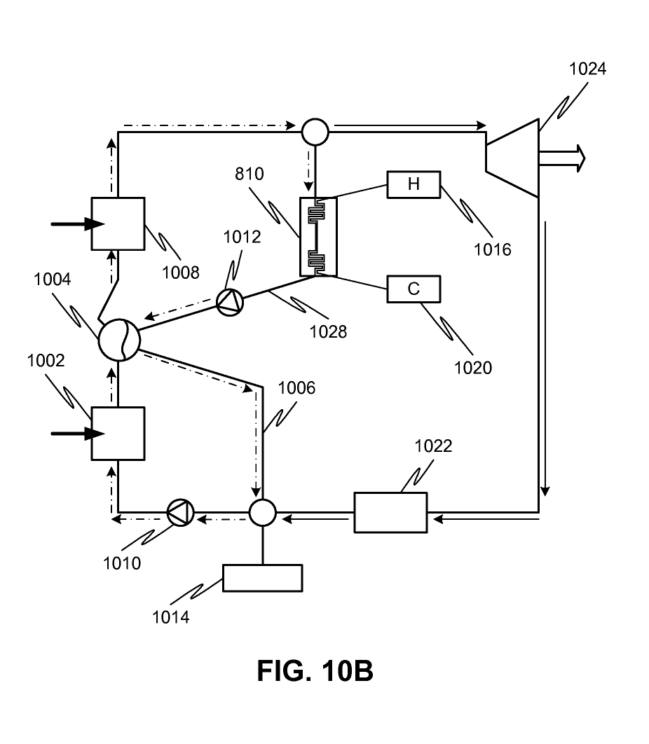

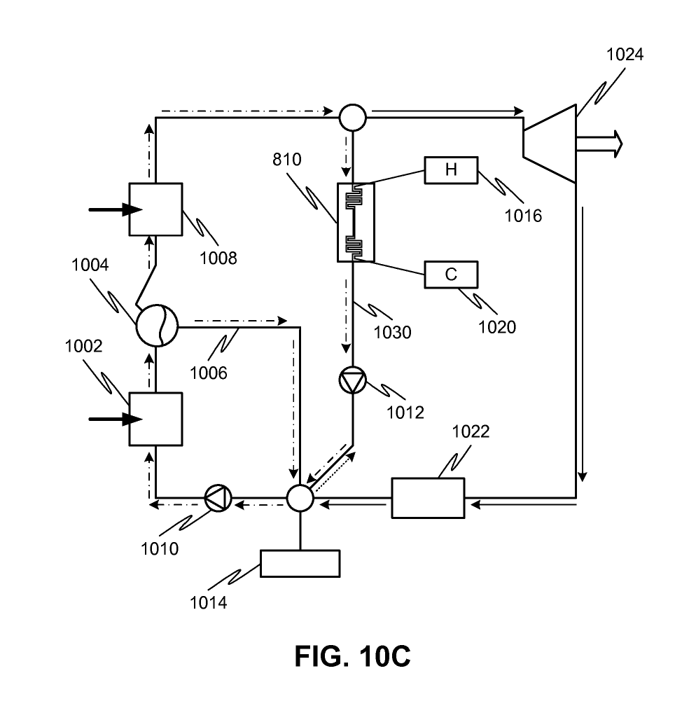

FIG. 10A illustrates various components of the systems of FIGS. 8-9 during charging and discharging of the thermal storage system 812. In FIG. 10A, the flow of fluids during the charging phase is represented by dash-dot arrows while the flow of fluids during the discharging phase is represented by dotted arrows. Solid arrows represent the flow of fluids that can remain the same regardless if the thermal storage system is charging or discharging. The solar collection system 802 can include a first solar receiver 1002 (i.e., an evaporating solar receiver) and a second solar receiver 1008 (i.e., a superheating solar receiver). The superheating solar receiver can have an insolation receiving capacity and/or size that exceeds the insolation receiving capacity and/or size of the evaporating solar receiver. For example, the power (in watts) of insolation used to superheat the steam in the superheating solar receiver can exceed the power of insolation used to generate steam in the evaporating solar receiver by at least 10%, 20%, 30%, or more.

Pressurized solar fluid in a first phase (e.g., pressurized liquid water or a pressurized mixture of liquid water and water vapor) can enter into solar receiver 1002. Insolation can cause the pressurized solar fluid to undergo a phase change to a second phase (e.g., pressurized steam). The solar collection system 802 can be configured as a multi-pass boiler, where a mixture of pressurized water and saturated steam is circulated by a feedwater pump 1010 via a recirculation loop 1006. Feedwater can also be provided to the solar collection system 802 from a feedwater supply 1014. A steam separation vessel, such as steam separation drum 1004, can be connected to the outlet of the first solar receiver 1002 and the inlet of the recirculation loop 1006. The steam separation vessel can ensure that pressurized saturated steam entering the second solar receiver 1008 is substantially liquid-free.

Steam enters the second solar receiver 1008 and is further heated by at least 50° C. (or at least 100° C., 150° C., or higher) so as to generate pressurized superheated steam. The steam can be at a pressure of at least 100 atmospheres, 160 atmospheres, or more. A first portion of the pressurized superheated steam is sent to turbine 1024 of electricity generation system 816, for example, to generate electricity. Steam and/or water at a reduced temperature and/or pressure can exit the turbine 1024 and return to the solar collection system 802 for re-use. A conditioner and/or condenser 1022 can be provided to convert the output from the turbine into pressurized water for use by the solar collection system. A second portion of the pressurized superheated steam is sent to heat exchanger assembly 810, which can include one or more heat exchangers. Within the heat exchanger assembly 810, enthalpy of the superheated steam is used to heat thermal storage medium in thermal storage system 812.

Storage medium in the thermal storage system 812 can flow from first reservoir 1020 to second reservoir 1016 by way of the heat exchanger assembly 810. After the pressurized superheated steam transfers enthalpy to the thermal storage medium, the solar fluid is at a lower thermal potential but remains at least partially in the vapor phase. For example, the solar fluid leaving the heat exchanger assembly 810 can be de-superheated steam and/or a mixture of steam and pressurized water having a temperature at or above the boiling point of the solar fluid at that pressure. Within heat exchanger assembly 810, the enthalpy transferred from the steam to the thermal storage system 812 can be used to heat thermal storage medium from an initial temperature to a final destination temperature. As the thermal storage medium is heated, it travels between the reservoirs. For example, heating/cooling of storage medium by enthalpy exchange can occur when the storage medium is en route between the first reservoir 1020 and the second reservoir 1116.

One or more pumps 1012, which can be reversible, can be used to convey the solar fluid output of heat exchanger assembly 810 for further use. For example, a second heat exchanger assembly 1018, which can include one or more separate heat exchangers, can be in thermal communication with the solar fluid output of heat exchanger assembly 810. The second heat exchanger assembly 1018 can also be in thermal communication with the recirculation loop 1006 of the first solar receiver 1002. The solar fluid output of the first heat exchanger assembly 810 can thus transfer enthalpy to the solar fluid in the recirculation loop 1006 by way of the second heat exchanger assembly 1018, thus serving to preheat the solar fluid provided to the first solar receiver 1002. The flows of feedwater and the solar fluid output through the second heat exchanger assembly 1018 can be controlled such that the transfer of enthalpy from the solar fluid output to the feedwater is sufficient to fully condense the solar fluid. For example, when the solar fluid output is de-superheated steam, the fluid flow through the second heat exchanger assembly can be regulated such that the solar fluid output is condensed into water below its boiling point after the enthalpy exchange in the second heat exchanger assembly. This regulation may be based on temperature differences between the input de-superheated steam and the input feedwater, relative flow capacities in the solar collection system, and/or system operating conditions.

Although FIG. 10A shows the solar fluid in the recirculation loop 1006 flowing in the same direction as the solar fluid on the other side of the second heat exchanger assembly 1018, this is for simplicity of illustration only. In practice, the solar fluids in the first and second heat exchanger assemblies can flow in a counter-flow configuration, cross-flow configuration, or any other configuration that can increase and/or maximize heat transfer efficiency. After the enthalpy exchange in the second heat exchanger assembly 1018, the solar fluid can be condensed (i.e., at a temperature below the boiling point of the solar fluid) and directed along output line 1026 to conditioner 1022 for reuse by the solar collection system.

Other uses for the solar fluid output of the heat exchanger assembly 810 are also possible according to one or more contemplated embodiments. For example, the solar fluid output can be directed back to the solar collection system for reuse therein. In FIG. 10B, the output line 1028 of the heat exchanger assembly 810 is directed to steam separation drum 1004 of the solar collection system. De-superheated steam and/or water from the first heat exchanger assembly 810 can thus be reintroduced into the solar collection system. Water in the output line 1028 can be separated from the steam in the output line 1028 within steam separation drum 1004. The steam can be then be directed to the second solar receiver 1008 for superheating along with steam from the first solar receiver 1002, while the water can be directed via recirculation loop 1006 to the first solar receiver 1002 for evaporating. In FIG. 10C, the output line 1030 of the heat exchanger assembly 810 is directed back to an input point for feedwater for recirculation loop 1006 for supplying pressurized water and/or steam to the first solar receiver 1002.

In another example (not shown), the solar fluid output from the first heat exchanger assembly 810 can be directed for use independent of the overall systems shown in FIGS. 10A-10C. For example, the solar fluid output can be directed to another heat exchanger for use in domestic or industrial heating. Alternatively or additionally, the solar fluid output can be used in the cultivation of microorganisms (e.g., algae or bacteria) for the production of biofuels. Alternatively or additionally, the solar fluid output can be used for fossil fuel production and/or extraction. Alternatively or additionally, the solar fluid output can be employed in any other process for which pressurized steam and/or heated pressurized water may be useful.

Referring again to FIG. 10A, when discharging is necessary, for example, due to a low insolation condition, pump 1012 can reverse direction so as to pump pressurized water from feedwater supply 1014 and/or turbine 1024 to heat exchanger 810. Within the heat exchanger assembly 810, enthalpy of the thermal storage medium in the thermal storage system 812 is used to heat the pressurized water. Storage medium in the thermal storage system 812 can flow from the second reservoir 1016 to the first reservoir 1020 by way of the heat exchanger assembly 810. The resulting steam can be conveyed to the turbine 1024 for use in generating electricity, for example. The steam can be at a lower pressure than that obtained via insolation generally but at about the same temperature obtained via insolation. The turbine 1024 can thus be configured to use the lower-pressure steam. For example, the turbine 1024 can be designed for a higher swallowing capacity so as to handle an increased steam flow rate to compensate for the decreased steam pressure. Alternatively, the turbine can include an additional steam inlet port for receiving lower pressure steam at a higher flow rate. The turbine can have a power capacity of 1 MW, 5 MW, 10 MW, 50 MW, 100 MW, 250 MW, 500 MW, or higher.

Although certain fluid flow pathways are indicated as common pathways in the charging and discharging phases in FIGS. 10A-10C, it is also contemplated that some of the pathways or additional flow pathways (not shown) can be used in the discharging phase that are not employed in the charging phase. For example, instead of flowing pressurized water through the second heat exchanger 1018 for input to the first heat exchanger 810 during the discharging phase, a bypass line can provide pressurized water directly from the supply (e.g., conditioner 1022 or feedwater supply 1014) to the input of the first heat exchanger assembly 810. In this manner, flow paths that are used in the charging phase, but which can be considered extraneous in the discharging phase, can be avoided.

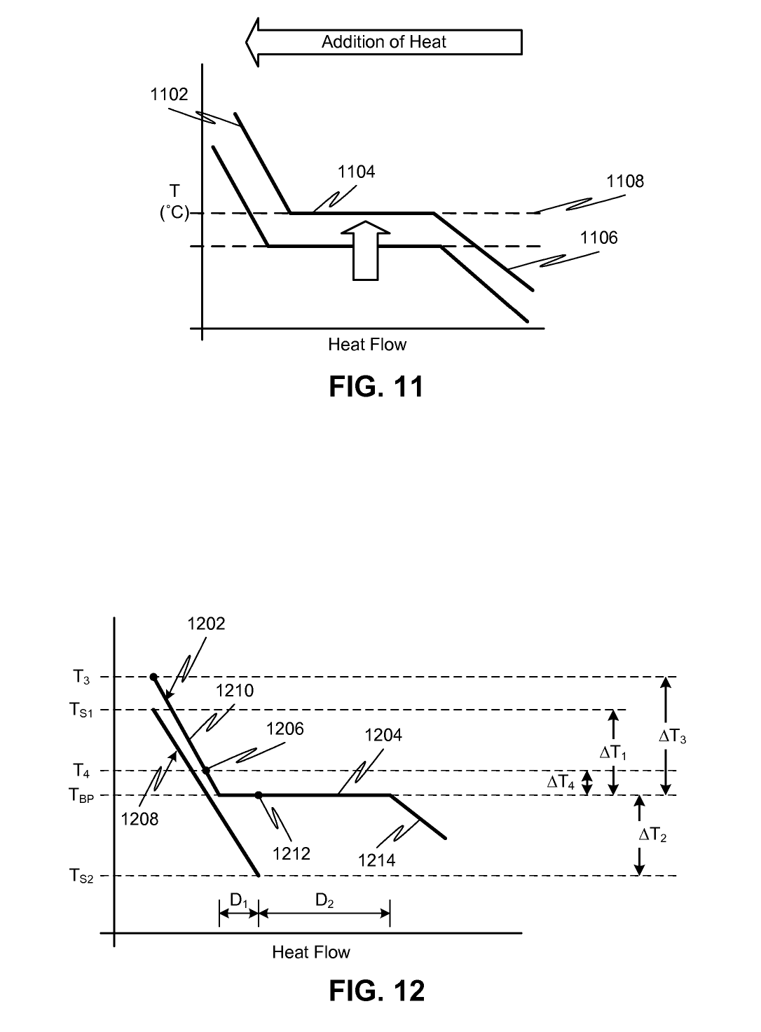

The heat exchange process with heat exchanger 810 can be a substantially isobaric process. For example, the pressure of water/steam in the heat exchanger 810 can be less than 500 bar, 400 bar, 350 bar, 300 bar, or less (but sufficiently high enough to exceed the critical point pressure for supercritical embodiments). Referring to FIG. 11, isobaric temperature-heat flow curves for a solar fluid such as water are shown. For example, for sub-critical-point heating of a solar fluid, the isobaric curve has a liquid phase portion 1106, a relatively flat phase change portion 1104, and a vapor phase portion 1102. At the flat phase change portion 1104 (which is at the boiling point or vaporization temperature of the solar fluid), the enthalpy transfer corresponds to changes in the latent heat of phase change of the solar fluid, while enthalpy transfers in the liquid phase portion 1106 or vapor phase portion 1102 correspond to changes in the sensible heat of the solar fluid reflected as change in temperature. Increasing pressure tends to increase the vaporization temperature of the working fluid and moves the curves in the direction of the block arrow in FIG. 11. These curves have not been drawn to scale or in any particular detail. Rather, they are merely for illustrative purposes only.

Referring to FIG. 12, temperature-heat flow curves are shown for the solar fluid and the thermal storage medium during a charging phase. The solar fluid, e.g., steam, is represented by curve 1202 while the thermal storage medium, e.g., molten salt, is represented by curve 1208. In the charging phase, the superheated steam enters the first heat exchanger at a pressure P and an initial temperature, T₃, which is above the boiling point temperature, T_{BP}, by an amount ΔT₃. For example, ΔT₃ can be at least 25° C., 50° C., 75° C., 100° C., 125° C., 150° C., 200° C., or more. The thermal storage medium enters the first heat exchanger at an initial temperature T_{S2}, which is below the boiling point temperature T_{BP} by an amount ΔT₂. For example, ΔT₂ can be at least 10° C., 20° C., 30° C., 40° C., 50° C., 75° C., 100° C., 150° C., or more.

As the steam loses enthalpy to the storage medium in the first heat exchanger, the temperature of the steam decreases along portion 1210 of curve 1202 while the temperature of the thermal storage medium increases along curve 1208. For portion 1210 of curve 1202, the enthalpy lost to the thermal storage medium is from the sensible heat of the vapor-phase solar fluid (e.g., steam). Once the temperature of the steam reaches the boiling point temperature, T_{BP}, it remains constant (corresponding to portion 1204 of curve 1202), while the temperature of the thermal storage medium continues to increase along curve 1208. For portion 1204 of curve 1202, the enthalpy lost to the thermal storage medium is from the latent heat of phase change of the solar fluid (e.g., the condensation of steam into water). However, as discussed above, the steam is not completely condensed by the heat transfer process with the thermal storage medium. Instead, the steam is at most partially condensed, for example, stopping at point 1212 along the phase change portion 1204 of curve 1202.

In some embodiments, the heat transfer process can be regulated such that none of the latent heat portion 1204 is used. For example, the heat transfer can stop at point 1206 corresponding to a final temperature, T₄, which is above the boiling point T_{BP} by an amount ΔT₄. A ratio of

$$\frac{Δ {T}_{4}}{Δ {T}_{3}}$$

can be at most 0.5, 0.4, 0.3, 0.2, 0.1, 0.05, or less. In other embodiments, the heat transfer process can be regulated such that none of the latent heat portion 1204 is used by stopping when the temperature of solar fluid first reaches the boiling point temperature T_{BP}. In still other embodiments, the heat transfer process can be regulated such that some or all of the latent heat portion 1204 is used but none of the sensible heat of the liquid phase portion 1214 of curve 1202 is used. The solar fluid can thus exit the first heat exchanger at a final temperature, T₄, which is at or above the boiling point temperature T_{BP}. The thermal storage medium exits the first heat exchanger at a final temperature, T_{S1}, above the boiling point temperature T_{BP} by an amount ΔT₁. For example, a ratio of

$$\frac{Δ {T}_{1}}{Δ {T}_{2}}$$

is at least 0.3, 0.4, 0.5, 0.6, 0.7, 0.8, 0.85, 0.9, 0.95, or more, and ΔT₁ can be at least 25° C., 50° C., 75° C., 100° C., 125° C., 150° C., 200° C., or more. A ratio of

$$\frac{{T}_{1}}{{T}_{3}}$$

can be at least 0.3, 0.4, 0.5, 0.6, 0.7, 0.8, 0.85, 0.9, 0.95, or more.

When the solar fluid is only partially condensed, the heat transfer ends at some point 1212 along the phase change portion 1204 of curve 1202. Because the phase change is incomplete, some of the solar fluid remains in the vapor phase (e.g., de-superheated pressurized steam) while the remainder has been converted to the liquid phase (e.g., pressurized water at the boiling point temperature T_{BP}). In FIG. 12, D₁ can correspond to the portion of the solar fluid which has been condensed into the liquid phase while D₂ can correspond to the portion of the solar fluid remaining in the vapor phase. For example,

$$\frac{{D}_{1}}{{D}_{1} + {D}_{2}}$$

can be less than 0.99, 0.9, 0.8, 0.7, 0.6, 0.5, 0.4, 0.3, 0.2, 0.1, or less. Alternatively or additionally,

$$\frac{{D}_{1}}{{D}_{1} + {D}_{2}}$$

can be greater than 0.2, 0.3, 0.4, 0.5, 0.6, 0.7, or greater. In one particular example,

$$\frac{{D}_{1}}{{D}_{1} + {D}_{2}}$$

is between 0.2 and 0.7. With increasing values of

$$\frac{{D}_{1}}{{D}_{1} + {D}_{2}}$$

the final temperature T_{S1} of the thermal storage medium can be less.

In one or more embodiments, the thermal storage system can include a control system, either as a shared component with the solar collection system and the electricity generation system (i.e., as part of an overall system controller) or a separate module particular to the thermal storage system (i.e., independent from but potentially interactive with other control modules). The control system can be configured to regulate flow of thermal storage medium within and between the different storage reservoirs. For example, the control system can regulate a rate of media flow between the reservoirs, a timing of the flow, an allocation parameter governing relative quantities of media in the reservoirs, or any other aspect governing the distribution of thermal storage medium within the system. The flow parameters can be governed in accordance with heat transfer parameters of the flow path between reservoirs. For example, the flow parameters can be based, at least in part, on the heat transfer parameters of the heat exchanger, a temperature of the solar fluid flowing through the heat exchanger, a flow rate of the solar fluid flowing through the heat exchanger, or any other aspects or conditions affecting the heat transfer between the thermal storage system and the solar fluid.

The control system can be configured to control other aspects of the overall system, including, for example, one or more parameters of the solar fluid. For example, the control system can be configured to regulate the temperature and/or flow rate of the solar fluid, at least partly in thermal communication with the heat exchanger. Moreover, the control system may regulate the flow of the solar fluid through the one or more heat exchangers, for example, to insure that the solar fluid does not fully condense after the enthalpy exchange with the thermal storage fluid during charging and/or to insure that the solar fluid fully condenses after the enthalpy exchange with the liquid-phase solar fluid input to the solar collection system. The control system can include any combination of mechanical or electrical components for accomplishing its goals, including but not limited to motors, pumps, valves, analog circuitry, digital circuitry, software (i.e., stored in volatile or non-volatile computer memory or storage), wired or wireless computer network(s) or any other necessary component or combination of component to accomplish its goals.

The temperature of the thermal storage medium can also be monitored within any of the thermal storage reservoirs or combination thereof. The temperature of the solar fluid after heat exchange with the thermal storage system can also be monitored. The control system can regulate flow parameters according to one or more of these measured temperatures. For example, the control system can use the measure temperatures and regulate responsively thereto in order to ensure that the temperature(s) of the solar fluid after heat exchange with the thermal storage system is at or above the boiling point temperature of the solar fluid. The measurement can be accomplished by any device known in the art. For example, the measurement can be direct (e.g., using a thermocouple or infrared sensor) or indirect (e.g., measuring a temperature in a location indicative of fluid temperature within a conduit or reservoir).

The teachings disclosed herein can be useful for increasing solar energy generation efficiency during days of intermittent cloudy periods, maximizing electricity production and/or revenue generation of a solar electric facility, and/or meeting reliability requirements of an electric transmission network operator. In one non-limiting example, during daylight hours, (i) sub-critical or super-critical steam is generated by subjecting pressurized liquid water to insolation; (ii) a first portion of the steam (e.g., after superheating) is used to drive a turbine; and (iii) a second portion of the steam is used to heat thermal storage fluid of the thermal storage system via heat conduction and/or convection to charge the thermal storage system. At night or other period of relatively low insolation, enthalpy of the thermal storage system (i.e., when the thermal storage system is discharged) is used to evaporate and/or superheat pressurized liquid water via heat conduction and/or convection between the hotter thermal storage fluid and the cooler pressurized liquid water. This steam generated by enthalpy from the thermal storage system can be used to drive the same turbine (or any other turbine) that was driven during daylight hours by steam generated primarily by insolation. In some embodiments, the turbine driven by enthalpy of the thermal storage system operates at a lower pressure than when drive by insolation alone.

Various embodiments described herein relate to insolation and solar energy. However, this is just one example of a source of intermittent energy. The teachings herein can be applied to other forms of intermittent energy as well, according to one or more contemplated embodiments. Steam can be generated by other sources of energy and used to charge a thermal storage system. For example, fossil fuels, electricity heaters, nuclear energy, or any other source could be used to generate steam for thermal storage. Although aspects of the present disclosure relate to the production of steam using insolation for the production of electricity, it is also contemplated that the teachings presented herein can be applied to solar thermal systems that convert insolation into any of a heated working fluid, mechanical work, and electricity. Although panel-type heliostats with a central solar tower are discussed above, the teachings of the present disclosure are not limited thereto. For example, redirection and/or concentration of insolation for heating a working fluid can be accomplished using an elongated trough reflector.

Although various embodiments of the thermal storage system are explained in terms of a specific case where the number of reservoirs is two, it is noted that fewer or greater than two reservoirs can also be used according to one or more contemplated embodiments. Moreover, some of the examples discussed herein relate to a single-phase thermal storage system for a multi-phase power generation systems. However, the teachings presented herein are not to be so limited. Rather, the teachings presented herein can be applicable to multi-phase thermal storage systems according to one or more contemplated embodiments. Moreover, while specific examples have been discussed with respect to using water/steam as a solar fluid, it is further contemplated that other solar fluids can be used as well. For example, salt-water and/or pressurized carbon dioxide can be used as a solar fluid. Other solar fluids are also possible according to one or more contemplated embodiments. In addition, while specific examples have been discussed with respect to using molten salt and/or molten metal as the thermal storage medium, it is contemplated that other types of thermal storage media can be used as well.

It will be appreciated that the modules, processes, systems, and sections described above can be implemented in hardware, hardware programmed by software, software instruction stored on a non-transitory computer readable medium or a combination of the above. A system for controlling the thermal storage system, the solar collection system, and/or the electricity generating system can be implemented, for example, using a processor configured to execute a sequence of programmed instructions stored on a non-transitory computer readable medium. The processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a non-transitory computer-readable medium such as a computer memory or storage device which can be any suitable memory apparatus, such as, but not limited to read-only memory (ROM), programmable read-only memory (PROM), electrically erasable programmable read-only memory (EEPROM), random-access memory (RAM), flash memory, disk drive, etc.

Furthermore, the modules, processes, systems, and sections can be implemented as a single processor or as a distributed processor. Further, it should be appreciated that the steps discussed herein can be performed on a single or distributed processor (single and/or multi-core). Also, the processes, modules, and sub-modules described in the various figures of and for embodiments above can be distributed across multiple computers or systems or can be co-located in a single processor or system. Exemplary structural embodiment alternatives suitable for implementing the modules, sections, systems, means, or processes described herein are provided below, but not limited thereto. The modules, processors or systems described herein can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example. Moreover, embodiments of the disclosed method, system, and computer program product can be implemented in software executed on a programmed general purpose computer, a special purpose computer, a microprocessor, or the like.

Embodiments of the method and system (or their sub-components or modules), can be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, etc. In general, any process capable of implementing the functions or steps described herein can be used to implement embodiments of the method, system, or a computer program product (software program stored on a non-transitory computer readable medium).

Furthermore, embodiments of the disclosed method, system, and computer program product can be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of solar collection, thermal storage, electricity generation, and/or computer programming arts.

Features of the disclosed embodiments can be combined, rearranged, omitted, etc., within the scope of the invention to produce additional embodiments. Furthermore, certain features can sometimes be used to advantage without a corresponding use of other features.

It is thus apparent that there is provided in accordance with the present disclosure, system, methods, and devices for thermal storage. Many alternatives, modifications, and variations are enabled by the present disclosure. While specific embodiments have been shown and described in detail to illustrate the application of the principles of the present invention, it will be understood that the invention can be embodied otherwise without departing from such principles. Accordingly, Applicant intends to embrace all such alternatives, modifications, equivalents, and variations that are within the spirit and scope of the present invention.

1. A method of generating electricity using insolation, comprising:
at a first operating period:
generating superheated steam at a pressure greater than atmospheric pressure using insolation;
using a first portion of the generated steam to drive a turbine so as to produce electricity;
directing a second portion of the generated steam to a first flowpath of a first heat exchanger in thermal communication with first and second thermal reservoirs; and
at a same time as said directing, flowing a storage medium from the first reservoir along a second flowpath of the first heat exchanger to the second reservoir such that:
enthalpy in the second portion of the generated steam in the first flowpath is transferred to the storage medium in the second flowpath so as to heat the storage medium from a first temperature less than a boiling point of water at said pressure to a second temperature greater than the boiling point of water,
fluid exiting from the first flowpath of the first heat exchanger has a temperature at or greater than the boiling point of water at said pressure, and
at least some of the fluid exiting the first flowpath of first heat exchanger remains in the form of steam; and
at a second operating period:
reverse-flowing the storage medium from the second reservoir along the second flowpath of the first heat exchanger to the first reservoir such that enthalpy in the storage medium in the second flowpath is transferred to pressurized water in the first flowpath of the first heat exchanger so as to generate steam; and
using the steam generated by said reverse-flowing to drive said turbine so as to produce electricity,
wherein the storage medium includes at least one of a molten salt and a molten metal, and
an insolation level during the first operating period is greater than an insolation level during the second operating period.

2. The method of claim 1, further comprising, at the first operating period:
directing said fluid exiting the first flowpath of the first heat exchanger to a third flowpath of a second heat exchanger in thermal communication with a feedwater line; and
flowing pressurized feedwater along a fourth flowpath of the second heat exchanger to a first solar receiver such that enthalpy in said fluid in the third flowpath is transferred to the feedwater in the fourth flowpath thereby preheating the feedwater.

3. The method of claim 2, wherein the flowing pressurized feedwater is such that all of said fluid in the third flowpath after the transfer of enthalpy to the feedwater in the fourth flowpath of the second heat exchanger is condensed into water.

4. The method of claim 2, wherein the feedwater line is connected to a water outlet of a steam separation drum arranged between the first solar receiver and a second solar receiver.

5. The method of claim 2, wherein the feedwater line is part of a recirculation loop for the first solar receiver.

6. The method of claim 1, further comprising, at the first operating period, directing said fluid exiting the first flowpath of the first heat exchanger to a steam separation drum arranged between a first solar receiver and a second solar receiver.

7. The method of claim 1, further comprising, at the first operating period, directing said fluid exiting the first flowpath of the first heat exchanger to an input feedwater line for an evaporating solar receiver.

8. The method of claim 1, wherein, at the first operating period, about all of the second portion of the generated steam directed to the first heat exchanger exits the first flowpath of the first heat exchanger in the form of steam.

9. The method of claim 1, wherein, at the first and second operating periods, storage medium in the second reservoir has a temperature greater than storage medium in the first reservoir.

10. The method of claim 1, wherein the first and second reservoirs are one of a fluid tank and a below grade pool.

11. The method of claim 1, wherein the storage medium is maintained in a liquid phase in the first and second storage reservoirs during both the first and second operating periods.

12. The method of claim 1, wherein the generating steam at the first operating period includes reflecting insolation onto one or more solar receivers using a plurality of heliostats.

13. A system for generating electricity from insolation, the system comprising:
a solar collection system constructed so as to generate steam from insolation;
a thermal storage system including first and second thermal storage reservoirs;
an electricity generating system including a turbine that uses steam to generate electricity, the electricity generating system being coupled to the solar collection system so as to receive generated steam therefrom;
a first heat exchanger by which the solar collection system and the thermal storage system are thermally coupled to each other such that enthalpy in one of the solar collection and thermal storage systems can be transferred to the other of the solar collection and thermal storage systems; and
a control system configured to control the thermal storage system such that:
at a first operating period, a storage medium flows from the first reservoir through the first heat exchanger to the second reservoir so as to transfer enthalpy in steam from the solar collection system to the storage medium by way of the first heat exchanger, the temperatures of all fluids exiting the first heat exchanger being at or above the boiling point of water; and
at a second operating period, the storage medium flows from the second reservoir through the first heat exchanger to the first reservoir so as to transfer enthalpy from the storage medium to water by way of the first heat exchanger.

14. The system of claim 13, further comprising a second heat exchanger by which a steam output line of the first heat exchanger is thermally coupled to a recirculation loop of the solar collection system such that enthalpy of steam in the output line of the first heat exchanger can be transferred to feedwater in the recirculation loop.

15. The system of claim 13, wherein a steam output line of the first heat exchanger is connected to a steam separation drum of the solar collection system.

16. The system of claim 13, wherein an output line of the first heat exchanger is connected to a feedwater input of the solar collection system.

17. The system of claim 13, wherein the first and second reservoirs are one of a fluid tank and a below grade pool.

18. The system of claim 13, wherein the first and second reservoirs are constructed to contain at least one of a molten salt and a molten metal.

19. The system of claim 13, wherein the solar collection system includes a solar receiver and a plurality of heliostats configured to reflect insolation onto the solar receiver.

20-46. (canceled)

47. A solar energy system comprising:
a first solar receiver in which pressurized feedwater is evaporated by insolation;
a second solar receiver in which pressurized steam is superheated by insolation;
a steam separation vessel in fluid communication with each of the first and second receivers;
a thermal energy storage system including a first reservoir and a second reservoir for a thermal storage medium selected from molten salt and molten metal;
a first heat exchanger assembly including one or more exchangers and configured to enable a heat transfer process between superheated steam and the thermal storage medium during charging of the thermal energy storage system, and between the thermal storage medium and pressurized water and/or steam during discharging; and
a conduit assembly including one or more conduits and configured to deliver de-superheated and at most partially condensed steam from the first heat exchanger assembly to one of the steam separation vessel, a feedwater loop, and a second heat exchanger assembly in thermal communication with the pressurized feedwater.

48. The system of claim 47, wherein the steam separation vessel is a steam separation drum.

49. The system of claim 47, wherein the second solar receiver receives the pressurized steam from the first solar receiver by way of the steam separation vessel.

50. The system of claim 47, wherein an insolation capacity of the second solar receiver is greater than an insolation capacity of the first solar receiver.
